(19) United States
(12) Patent Application Publication
(10) Pub. No.: US 2004/0153858 A1
(43) Pub. Date: Aug. 5, 2004

(54) Direct peer-to-peer transmission protocol between two virtual networks

(76) Inventor: Shaw Hwa Hwang, Hsinchu City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/622,579

(22) Filed: Jul. 21, 2003

(30) Foreign Application Priority Data
Dec. 23, 2002 (TW) 91136979

(51) Int. Cl. H04B 1/74

(52) U.S. Cl. 714/43

(57) ABSTRACT

A direct P2P transmission protocol between two virtual networks is disclosed in the invention, which is implemented on the Internet and includes three procedures: the login procedure, the testing Network Address Translation (NAT) procedure, and the direct data transmission procedure. Among them, the location server located in the real Internet is to support the login procedure and the testing NAT procedure, and then the direct data transmission procedure can be executed after the detection of NAT-based router parameters has been completed. The direct data transmission procedure, however, can do direct data packet transmission between two virtual IP networks without support from any proxy server. In addition, because the login procedure almost occupies none of the bandwidth resource and the testing NAT procedure takes very little connection time for completion, the direct data transmission between two virtual IP points can thus be executed with plenty of time and in large quantity.

### BACKGROUND OF THE INVENTION

1. Field of the Invention

The invention relates to a protocol based on the TCP/IP on the Internet and, more particularly, to a direct peer-to-peer transmission (DP2PT) protocol between two virtual networks.

2. Description of the Related Art

Owing to fast growing of the Internet, the space for the four-byte IP (Internet Protocol) address that employs the Ipv4 (Internet Protocol version 4) is not big enough for use, and in order to solve the problem, the Network Address Translation (NAT) has been widely employed in the design of routers.

When using a NAT-based router, only one real IP address is required externally, but an unlimited number of virtual IP addresses can be expanded internally. Besides, through the translation made by the NAT-based router, the users of virtual IP addresses can connect to and access data from the external real IP address. However, the external real IP address cannot connect to and access data from the virtual IP addresses. Therefore, the functions of a NAT-based router are to solve the problem of insufficient real IP address and work as a firewall for the network security. For this reason, over ninety percent of the enterprises are using NAT-based routers to cope with problems caused by the IP address shortage and the network security.

In addition, the conventional client-server network communication architecture has been gradually replaced by the peer-to-peer (P2P) architecture along with the prosperity of network development. However, since a large number of users have to work in a virtual IP environment when using the P2P architecture, the virtual IP environment has become a serious bottleneck in P2P communication. Unfortunately, the two network communication protocols H.323 and SIP cannot effectively solve the directly communication problem between the two virtual Internet protocols.

The reason why the real IP address cannot be connected to the virtual IP addresses is that the virtual IP addresses are private and illegal web addresses according to the protocols of Internet. So far, there are two methods that can overcome the packet transmission problems among the virtual IP addresses. One method is to employ a proxy server, but the bandwidth limitation is its drawback. Another method is to apply a proxy server and a NAT-based router together with some software, but the technique of such method is limited as well. Besides, some NAT-based routers do not supply plug-in proxy server. Therefore, even though the above-mentioned two methods can overcome the problem of virtual IP address, they cannot be likewise applied to the direct P2P communication between virtual networks. In other words, no conventional technique of direct P2P transmission protocol between two virtual networks has ever been introduced before. Thus, the objective of the invention is to provide a direct P2P transmission protocol between two virtual networks.

### SUMMARY OF THE INVENTION

The object of the invention is to provide a specific Internet protocol that allows the peer-to-peer packets to be directly transmitted between two virtual networks without being transmitted by a third-party or a proxy server so as to solve the problem that the current network telephone is not applicable in the environment of virtual network.

Another object of the invention is to provide a direct peer-to-peer transmission protocol between two virtual networks, which can be widely applied to the fields such as network telephone, image telephone, and Public Switched Telephone Network (PSTN).

The protocol disclosed in the invention is to be implemented in the Internet, including three procedures: the login procedure, the testing NAT procedure, and the direct data transmission procedure. Among them, the location server located in the real Internet is to support the login procedure and the testing NAT procedure, and then the direct data transmission procedure can be executed after the detecting of NAT-based router parameters has been completed. The direct data transmission procedure, however, can do direct data packet transmission between two virtual IP networks without assistance from any proxy server.

The objects and technical contents of the invention will be better understood through the description of the following embodiments with reference to the drawings.

### BRIEF DESCRIPTION OF THE DRAWINGS

FIG. 1 is a schematic diagram showing that two virtual networks of the invention can do direct P2P transmission.

FIG. 2 is a schematic diagram showing the direct P2P transmission protocol between two virtual networks of the invention.

FIG. 3 is a schematic diagram showing the simplified transmission protocol of the invention.

FIG. 4 is a schematic diagram showing the distributed server protocol of the invention.

### DETAILED DESCRIPTION OF THE PREFERRED EMBODIMENTS

The invention provides a specific Internet protocol that allows the peer-to-peer packets to be directly transmitted between two virtual networks without being transmitted by a third-party or a proxy server so as to solve the problem that the current network telephone is not applicable in the environment of virtual network.

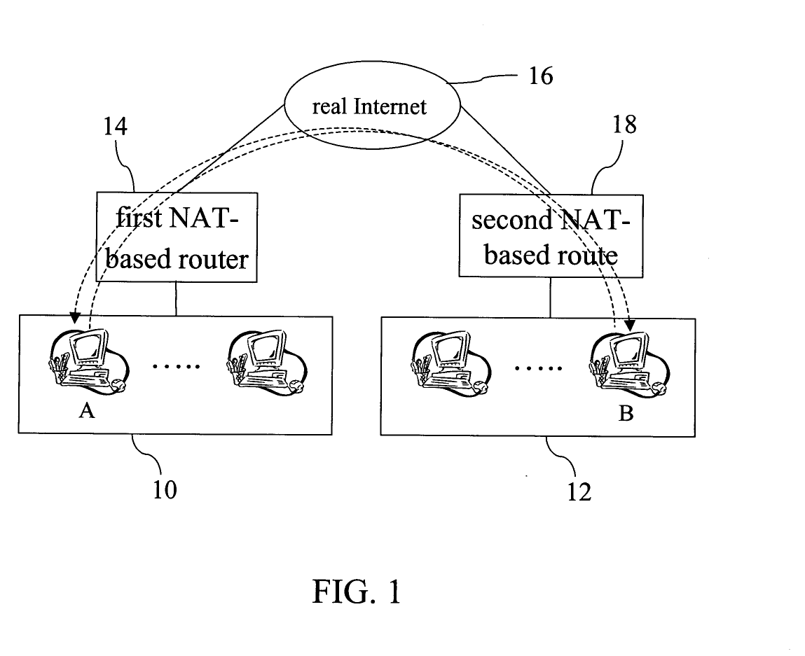

FIG. 1 is a schematic diagram showing that two virtual networks of the invention can do direct P2P transmission. As shown in FIG. 1, each of the first virtual network 10 and the second virtual network 12 separately belongs to a virtual network. Besides, the first NAT-based router 14 is a bridge for communication translation between the first virtual network 10 and the real Internet 16, whereas the second NAT-based router 18 is a bridge for communication translation between the second virtual network 12 and the real Internet 16. In addition, a packet between the point A of the first virtual network 10 and the point B of the second virtual network 12 can be directly transmitted to each other through the real Internet 16. Therefore, the communication technique can be broadly applied to the fields such as network telephone, image telephone, peer-to-peer communication system and Public Switch Telephone Network.

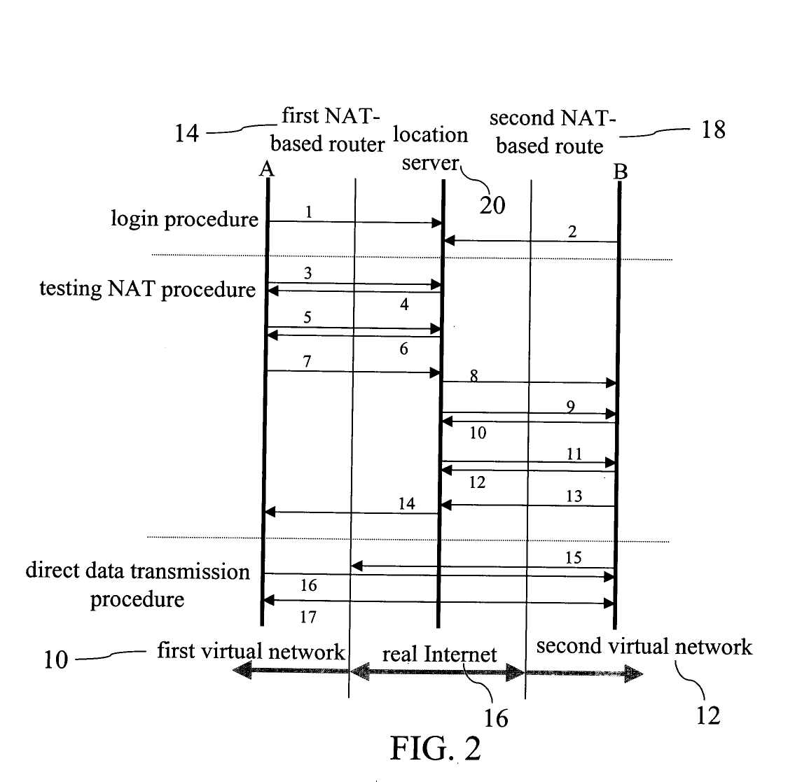

The Internet protocol provided by the invention is shown in FIG. 2. The first virtual IP A (hereinafter referred to as the A), which is shown in FIG. 2 as point A, represents a communication point inside the first virtual network 10. On the other hand, the first virtual IP B (hereinafter referred to as the B), which is shown in FIG. 2 as point B, represents a communication point inside the second virtual network 12. Also, the first NAT-based router 14 and the second NAT-based router 18 are routers separately used by the first virtual network 10 and the second virtual network 12 respectively for communicating to the external real Internet 16. In addition, a location server 20 is to support the establishment of communication. When the A of the first virtual network 10 is to be directly communicated to the B of the second virtual network 12, there are seventeen steps that have to be gone through. The seventeen steps are categorized into three procedures, including the login procedure, the testing NAT procedure, and the direct data transmission procedure. The details about the seventeen steps of the invention will be described below with reference to the process flow shown in FIG. 2.

(A) Login Procedure

Step 1: The A utilizes Transmission Control Protocol (TCP) or User Datagram Protocol (UDP) for building up connection with the location server 20 and keeping the connection as well.

Step 2: The B utilizes TCP or UDP for building up connection with the location server 20 and keeping the connection as well.

(B) Testing NAT Procedure

Step 3: The A utilizes UDP for sending out a testing packet to the location server 20.

Step 4: The location server 20 returns an information number x1 of the source port of the testing packet to the A.

Step 5: The A utilizes UDP again for sending out another testing packet to the location server 20.

Step 6: The location server 20 again returns an information number x2 of the source port of the testing packet to the A.

Step 7: The A sends out information about x2 and the value of dx2 (=x2−x1) to the location server 20.

Step 8: The location server 20 transmits x2 and dx2 to the B through a connection to the login procedure.

Step 9: The B utilizes UDP for sending out a testing packet to the location server 20.

Step 10: The location server 20 returns an information number y1 of the source port of the testing packet to the B.

Step 11: The B utilizes UDP again for sending out another testing packet to the location server 20.

Step 12: The location server 20 again returns an information number y2 of the source port of the testing packet to the B.

Step 13: The B sends out information about y2 and the value of dy2 (=y2−y1) to the location server 20.

Step 14: The location server 20 transmits y2 and dy2 to the A through a connection to the login procedure.

(C) Direct Data Transmission Procedure

Step 15: The B sends out the UDP data packet, whose destination port is x2+dx2, to the first NAT-based router 14, and the data packet will be discarded by the first NAT-based router 14.

Step 16: The A sends out UDP data packet, whose destination port is y2+dy2, to the second NAT-based router 18, wherein the second NAT-based router 18 will directly transmit the data packet to the B, and the direct transmission procedure will then be completed.

Step 17: The B will reply to the A, and the direct data transmission is executed between the A and the B.

According to the protocol in FIG. 2, before the two virtual IP points (the point A and the point B) can be directly transmitted, the login procedure needs an aid from the location server 20 and the procedure of detecting parameters of the NAT-based routers 14 and 18 must be finished. However, the login procedure almost occupies none of the bandwidth resource, and the procedure of detecting parameter of the NAT-based router 14 and 18 takes very little connection time because the procedure can be completed in extremely short time. Thus, direct data transmission between two virtual IP points can be executed with plenty of time and in large quantity without any support from a proxy server for data transmission. Therefore, the protocol has made a major breakthrough in the P2P communication system.

The protocol provided in FIG. 2 is designed by focusing on the NAT-based router. The NAT-based router is to change the source IP address and the source port of the packet sent out by the virtual IP address so that the packet data can be transmitted in the environment of real Internet. On the other hand, the packet data replied by the remote terminal can do a reverse transmission through the NAT-based router so as to reply to the source virtual IP address.

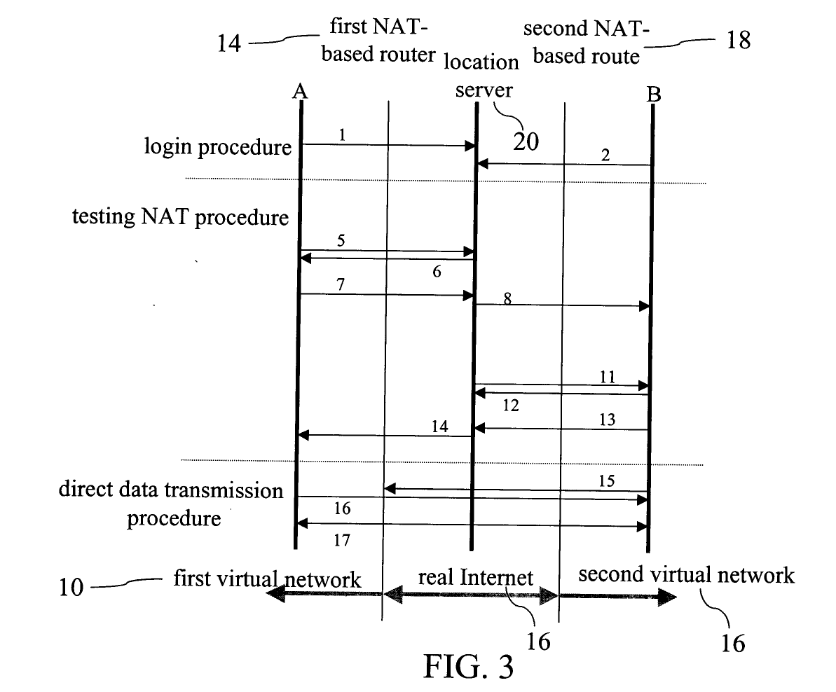

In addition, considering the convenience and effectiveness of the system design, most of the NAT-based routers therefore employ port numbers that are consecutive and incremented by one to change the source port for the new packet. Therefore, in the aforementioned protocol, the value of dx2 and dy2 is often to be 1. For this reason, the invention can employ another protocol called “simplified protocol”, which is shown in FIG. 3 and will be explained below.

### Simplified Protocol

The simplified protocol is first to skip the steps 3, 4, 9, and 10 of the protocol shown in FIG. 2. Then, the value of dx2 and dy2 is set as 1. Next, as shown in FIG. 3, all the A has to do is send out a testing packet to the location server 20, and then the location server 20 will return a source port number x1 of the testing packet to the A without sending out another testing packet. Similarly, all the B has to do is send out a testing packet to the location server 20 to get a source port number y1 of the testing packet. Also, x1+1(dx2) and y1+1(dy2) will be separately utilized as a destination port so that direct data transmission between the A and the B can be executed. As for the rest of the steps in the simplified protocol, they are exactly the same as the aforementioned steps and therefore will not be reiterated.

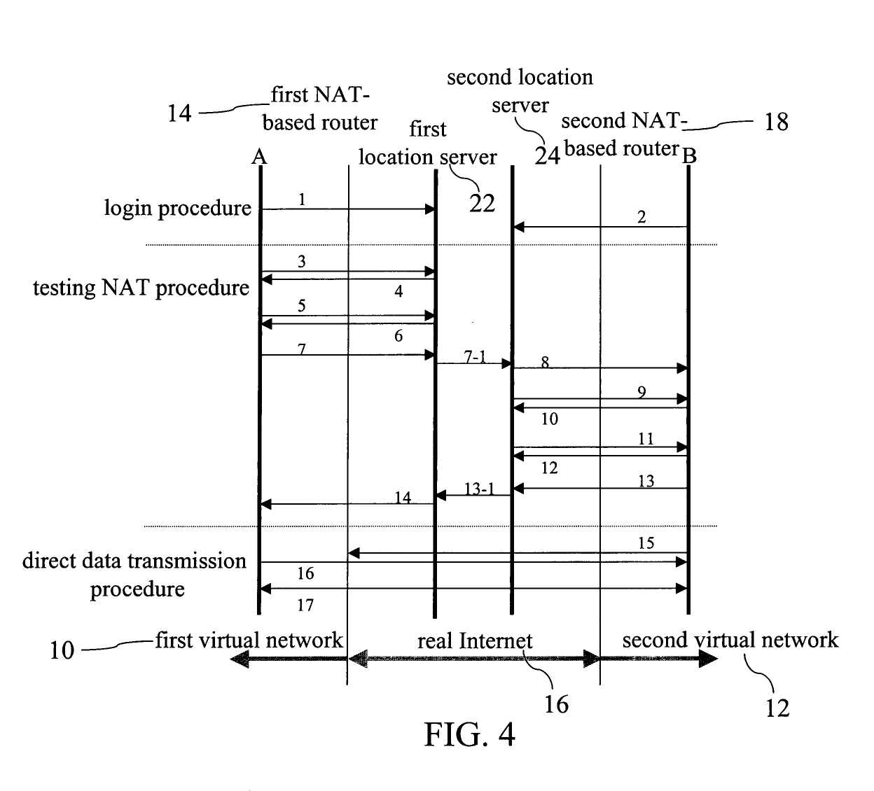

Furthermore, if the users in the virtual IP are excessive, the location server will be overloaded. Moreover, if the users in the virtual IP are globally distributed, the long-distance communication will prolong the delay time of the testing packet procedure, which in turn may result in a communication failure. In view of the problem, another alternative is available in the invention, which is a distributed server protocol shown in FIG. 4. In the following, the distributed server protocol will be well explained.

### Distributed Server Protocol

The distributed server protocol is first to divide the location server 20 of the protocol in FIG. 2 into two, including the first location server 22 and the second location server 24. Then, step 7-1 and step 13-1 are added into the testing NAT procedure to facilitate data transmission among different servers, as shown in FIG. 4. The process flow of the distributed server protocol will be described below.

(A) Login Procedure

Step 1: The A utilizes TCP or UDP for building up connection with the first location server 22 and keeping the connection as well.

Step 2: The B utilizes TCP or UDP for building up connection with the second location server 24 and keeping the connection as well.

(B) Testing NAT Procedure

Step 3: The A utilizes UDP for sending out a testing packet to the first location server 22.

Step 4: The first location server 22 returns an information number x1 of the source port of the testing packet to the A.

Step 5: The A utilizes UDP again for sending out another testing packet to the first location server 22.

Step 6: The first location server 22 again returns an information number x2 of the source port of the testing packet to the A.

Step 7: The A sends out information about x2 and the value of dx2 (=x2−x1) to the first location server 22.

Step 7-1: The first location server 22 transmits the information about x2 and dx2 from the A to the second location server 24.

Step 8: The second location server 24 transmits x2 and dx2 to the B through a connection to the login procedure.

Step 9: The B utilizes UDP for sending out a testing packet to the second location server 24.

Step 10: The second location server 24 returns an information number y1 of the source port of the testing packet to the B.

Step 11: The B utilizes UDP again for sending out another testing packet to the second location server 24.

Step 12: The second location server 24 again returns an information number y2 of the source port of the testing packet to the B.

Step 13: The B sends out information about y2 and the value of dy2 (=y2−y1) to the second location server 24.

Step 13-1: The second location server 24 sends out information about y2 and dy2 from the B to the first location server 22.

Step 14: The first location server 22 transmits y2 and dy2 to the A through a connection to the login procedure.

(C) Direct Data Transmission Procedure

Step 15: The B sends out the UDP data packet, whose destination port is x2+dx2, to the first NAT-based router 14, and the data packet will be discarded by the first NAT-based router 14.

Step 16: The A sends out UDP data packet, whose destination port is y2+dy2, to the second NAT-based router 18, wherein the second NAT-based router 18 will directly transmit the data packet to the B, and the direct transmission procedure will then be completed.

Step 17: The B will reply to the A, and thus direct data transmission is executed between the A and the B.

Since the virtual IP users in the NAT-based router may become a lot, the flow of packets may become plenty as a result. Therefore, in the protocols shown in FIGS. 2, 3, and 4, if the steps from 5 to 16 are being executed on account of the A when a user of another virtual IP cuts in and sends out a new packet, then the direct transmission between the A and the B will fail. Likewise, if the steps from 11 to 15 are being executed on account of the B when a user of another virtual IP cuts in and sends out a new packet, the same failure may happen between the A and the B. For this reason, the invention adopts another protocol called “improved protocol” to cope with such possible situations. The detail of the improved protocol will be illustrated in the Diagram 1 below, wherein the “inconsecutive situation of the A's source port” represents the situation that the steps from 5 to 16 are being executed on account of the A when a user of another virtual IP cuts in and sends out a new packet, the “0” represents no cut-in user, and the “2” represents two cut-in new packets from other virtual IP. On the other hand, the “inconsecutive situation of the B's source port” represents the situation that the steps from 11 to 15 are being executed on account of the B when a user of another virtual IP cuts in and sends out a new packet, the “0” represents no cut-in user, and the “2” represents two cut-in new packets from other virtual IP. Moreover, since time difference between step 5 and step 16 on account of the A is longer than that of step 11 and step 15 on account of the B, the A is more liable to be cut in. For this reason, the invention will adjust the value of “k” and the contents of the “inconsecutive situation of the A's source port” shown in Diagram 1 upon requirement so that the probability of success in communication can be increased.

Diagram 1

| | Destina- | | | |
|---|---|---|---|---|
| UDP | tion Port | Destination | Inconsecutive | Inconsecutive |
| Packet | of UDP | Port of UDP | Situation of | Situation of |
| Serial | Sent Out | Sent Out | the A's | the B's |
| Number | by the A | by the B | Source Port | Source Port |
| 1 | y2 + dy2 | x2 + dx2 | 0 | 0 |
| 2 | y2 + 2 * dy2 | x2 + 3 * dx2 | 1 | 0 |
| 3 | y2 + 4 * dy2 | x2 + 3 * dx2 | 0 | 1 |
| 4 | y2 + 5 * dy2 | x2 + 5 * dx2 | 1 | 1 |
| 5 | y2 + 5 * dy2 | x2 + 7 * dx2 | 2 | 0 |
| 6 | y2 + 8 * dy2 | x2 + 6 * dx2 | 0 | 2 |
| . | . | . | . | . |
| . | . | . | . | . |
| . | . | . | . | . |
| K | y2 + (k + | x2 + (k + k1) * | k1 | k2 |
| | k2) * dy2 | dx2 | | |

### Improved Protocol

The improved protocol means that in the protocol shown in FIGS. 2, 3, and 4, the steps 15 and 16 will be changed so that a number of UDP packets in an order of k consecutive numbers with different destination ports will be sent out to the NAT-based router at the opposite end. The consecutive numbers of the destination port of the k UDP packets sent out by the A and the B are as shown in Diagram 1. However, only one of the k UDP packets that is sent out at the step 16 on account of the A will be successfully sent out to the B and thus complete the direct communication procedure.

Hence, the direct P2P transmission protocol between two virtual networks disclosed in the invention is a brand new protocol that allows direct transmission of the P2P packets between two virtual networks without being transmitted through a third party or a proxy server. Thus, the problem that the standard of the current network telephone is inapplicable to the virtual network can be solved. Meanwhile, the new protocol of the invention can be applied to the network telephone, image telephone, and the PSTN as well.

What is claimed is:

1. A direct peer-to-peer transmission protocol between two virtual networks, including the following procedures:
(A) the login procedure, wherein a user in the virtual IP is keeping a connection with the location server of the real IP;
(B) the testing Network Address Translation (NAT) procedure, which includes the following sub-procedures:
(B1) the calling end of the first virtual IP obtains the source port information of the first NAT-based router through the location server, and the same information will be transmitted to the called end of the second virtual IP through the same location server; and
(B2) the called end of the second virtual IP receives the source port information from the calling end and then obtains the source port information of the second NAT-based router through the location server, and the same information will be transmitted back to the calling end of the first virtual IP through the same location server; and
(C) the direct data transmission procedure, which is located in the NAT-based router that allows data packet to be mutually transmitted between the first virtual IP and the second virtual IP, including the following two situations:
(C1) if the first virtual IP sends out the data packet first, then the second NAT-based router will discard the data packet, and, meanwhile, the transmission path for the first NAT-based router will be open, allowing the data packet transmitted by the second virtual IP subsequently to go through and complete the direct data transmission procedure; and
(C2) if the second virtual IP sends out the data packet first, then the first NAT-based router will discard the data packet, and, meanwhile, the transmission path for the second NAT-based router will be open, allowing the data packet transmitted by the first virtual IP subsequently to go through and complete the direct data transmission procedure.

2. The direct peer-to-peer transmission protocol between two virtual networks as claimed in claim 1, wherein the user in the virtual IP is using the Transmission Control Protocol (TCP) for keeping the connection with the location server.

3. The direct peer-to-peer transmission protocol between two virtual networks as claimed in claim 1, wherein the user in the virtual IP is using the User Datagram Protocol (UDP) for keeping the connection with the location server.

4. The direct peer-to-peer transmission protocol between two virtual networks as claimed in claim 1, wherein the data packet is selected from either the TCP data packet or the UDP data packet.

5. The direct peer-to-peer transmission protocol between two virtual networks as claimed in claim 1, wherein the procedure (B1) further includes the following steps:
the first virtual IP sends out a testing packet to the location server;
the location server returns the first source port information of the testing packet to the first virtual IP;
the first virtual IP sends out another testing packet to the location server;
the location server again returns the second source port information of the testing packet to the first virtual IP;
the first virtual IP totals up the second source port information and the difference of the information for obtaining the destination port information and then transmits the destination port information to the location server; and
the location server transmits the destination port information for the first NAT-based router to the second virtual IP.

6. The direct peer-to-peer transmission protocol between two virtual networks as claimed in claim 5, wherein the difference is an absolute difference between the first source port information and the second source port information.

7. The direct peer-to-peer transmission protocol between two virtual networks as claimed in claim 1, wherein the procedure (B2) further includes the following steps:
the second virtual IP sends out a testing packet to the location server;
the location server returns the third source port information of the testing packet to the second virtual IP;
the second virtual IP sends out another testing packet to the location server;
the location server again returns the fourth source port information of the testing packet to the second virtual IP;
the second virtual IP totals up the fourth source port information and the difference of the information for obtaining the destination port information and then transmits the destination port information to the location server; and
the location server transmits the destination port information for the second NAT-based router to the first virtual IP.

8. The direct peer-to-peer transmission protocol between two virtual networks as claimed in claim 7, wherein the difference is an absolute difference between the third source port information and the fourth source port information.

9. The direct peer-to-peer transmission protocol between two virtual networks as claimed in claim 1, wherein the procedure (B1) further includes the following steps:
the first virtual IP sends out a testing packet to the location server;
the location server returns the source port information of the testing packet to the first virtual IP;
the first virtual IP totals up the source port information and a preset difference for obtaining destination port information and then transmits the destination port information to the location server; and
the location server transmits the destination port information for the first NAT-based router to the second virtual IP.

10. The direct peer-to-peer transmission protocol between two virtual networks as claimed in claim 9, wherein the value of the preset difference is 1.

11. The direct peer-to-peer transmission protocol between two virtual networks as claimed in claim 1, wherein the procedure (B2) further includes the following steps:
the second virtual IP sends out a testing packet to the location server;
the location server returns the source port information of the testing packet to the second virtual IP;
the second virtual IP totals up the source port information and the preset difference of the information for obtaining the destination port information and then transmits the destination port information to the location server; and
the location server transmits the destination port information for the second NAT-based router to the first virtual IP.

12. The direct peer-to-peer transmission protocol between two virtual networks as claimed in claim 11, wherein the value of the preset difference is 1.

13. The direct peer-to-peer transmission protocol between two virtual networks as claimed in claim 1, wherein in the procedure (C1), the first virtual IP can send out a plurality of different port data packets in a consecutive manner to the second NAT-based router, and the second virtual IP can also send out a plurality of different port data packets in a consecutive manner to the first NAT-based router.

14. The direct peer-to-peer transmission protocol between two virtual networks as claimed in claim 13, wherein among the port data packets sent out by the first virtual IP, only one of the data packets can be successfully delivered to the second NAT-based router, whereas among the port data packets sent out by the second virtual IP, only one of the data packets can be successfully delivered to the first NAT-based router.

15. The direct peer-to-peer transmission protocol between two virtual networks as claimed in claim 1, wherein in the procedure (C2), the second virtual IP can send out a plurality of different port data packets in a consecutive manner to the first NAT-based router, and the fisrt virtual IP can also send out a plurality of different port data packets in a consecutive manner to the second NAT-based router.

16. The direct peer-to-peer transmission protocol between two virtual networks as claimed in claim 15, wherein among the port data packets sent out by the second virtual IP, only one of the data packets can be successfully delivered to the first NAT-based router, whereas among the port data packets sent out by the first virtual IP, only one of the data packets can be successfully delivered to the second NAT-based router.

17. A direct peer-to-peer transmission protocol between two virtual networks, including the following procedures:
(A) the login procedure, wherein the user in the virtual IP is keeping a connection with the location server of the real IP;
(B) the testing Network Address Translation (NAT) procedure, which includes the following sub-procedures:
(B1) the calling end of the first virtual IP obtains the source port information of the first NAT-based router through the first location server;
(B2) the first virtual IP transmits the source port information of the first NAT-based router to the second location server through the first location server;
(B3) the called end of the second virtual IP receives the source port information from the calling end through the second location server and then obtains the source port information of the second NAT-based router through the second location server; and
(B4) the second virtual IP utilizing the second location server for transmitting the source port information of the second NAT-based router back to the first location server, and then the information will be transmitted to the calling end of the first virtual IP; and
(C) the direct data transmission procedure, which is located in the NAT-based router that allows data packet to be mutually transmitted between the first virtual IP and the second virtual IP, including the following two situations:
(C1) if the first virtual IP sends out the data packet first, then the second NAT-based router will discard the data packet, and, meanwhile, the transmission path for the first NAT-based router will be open, allowing the data packet transmitted by the second virtual IP subsequently to go through and complete the direct data transmission procedure; and
(C2) if the second virtual IP sends out the data packet first, then the first NAT-based router will discard the data packet, and, meanwhile, the transmission path for the second NAT-based router will be open, allowing the data packet transmitted by the first virtual IP subsequently to go through and complete the direct data transmission procedure.

18. The direct peer-to-peer transmission protocol between two virtual networks as claimed in claim 17, wherein the user in the virtual IP is using the Transmission Control Protocol (TCP) for keeping the connection with the location server.

19. The direct peer-to-peer transmission protocol between two virtual networks as claimed in claim 17, wherein the user in the virtual IP is using the User Datagram Protocol (UDP) for keeping the connection with the location server.

20. The direct peer-to-peer transmission protocol between two virtual networks as claimed in claim 17, wherein the data packet is selected from either the TCP data packet or the UDP data packet.

21. The direct peer-to-peer transmission protocol between two virtual networks as claimed in claim 17, wherein the procedure (B1) further includes the following steps:
the first virtual IP sends out a testing packet to the first location server;
the first location server returns the first source port information of the testing packet to the first virtual IP;
the first virtual IP sends out another testing packet to the first location server;
the first location server again returns the second source port information of the testing packet to the first virtual IP;
the first virtual IP totals up the second source port information and the difference of the information for obtaining the destination port information and then transmits the destination port information to the first location server; and
the first location server transmits the destination port information for the first NAT-based router to the second location server.

22. The direct peer-to-peer transmission protocol between two virtual networks as claimed in claim 21, wherein the difference is an absolute difference between the first source port information and the second source port information.

23. The direct peer-to-peer transmission protocol between two virtual networks as claimed in claim 17, wherein the procedure (B3) further includes the following steps:
a) the second virtual IP sends out a testing packet to the second location server;
b) the second location server returns the third source port information of the testing packet to the second virtual IP;
c) the second virtual IP again sends out another testing packet to the second location server;
d) the second location server again returns the fourth source port information of the testing packet to the second virtual IP;
e) the second virtual IP totals up the fourth source port information and the difference of the information for obtaining destination port information and transmits the destination port information to the second location server; and
f) the second location server transmits the destination port information for the second NAT-based router to the first location server.

24. The direct peer-to-peer transmission protocol between two virtual networks as claimed in claim 23, wherein the difference is an absolute difference between the third source port information and the fourth source port information.

25. The direct peer-to-peer transmission protocol between two virtual networks as claimed in claim 17, wherein the procedure (B1) further includes the following steps:
the first virtual IP sends out a testing packet to the first location server;
the first location server returns the source port information of the testing packet to the first virtual IP;
the first virtual IP totals up the source port information and the preset difference of the information for obtaining the destination port information and then transmits the destination port information to the first location server; and

26. The direct peer-to-peer transmission protocol between two virtual networks as claimed in claim 25, wherein the value of the preset difference is 1.

27. The direct peer-to-peer transmission protocol between two virtual networks as claimed in claim 17, wherein the procedure (B3) further includes the following steps:
the second virtual IP sends out a testing packet to the second location server;
the second location server returns the source port information of the testing packet to the second virtual IP;
the second virtual IP totals up the source port information and the preset difference of the information for obtaining the destination port information and then transmits the destination port information to the second location server; and
the second location server transmits the destination port information for the second NAT-based router to the first virtual IP.

28. The direct peer-to-peer transmission protocol between two virtual networks as claimed in claim 27, wherein the value of the preset difference is 1.

29. The direct peer-to-peer transmission protocol between two virtual networks as claimed in claim 17, wherein in the procedure (C1), the first virtual IP can send out a plurality of different port data packets in a consecutive manner to the second NAT-based router, and the second virtual IP can also send out a plurality of different port data packets in a consecutive manner to the first NAT-based router.

30. The direct peer-to-peer transmission protocol between two virtual networks as claimed in claim 29, wherein among the port data packets sent out by the first virtual IP, only one of the data packets can be successfully delivered to the second NAT-based router, whereas among the port data packets sent out by the second virtual IP, only one of the data packets can be successfully delivered to the first NAT-based router.

31. The direct peer-to-peer transmission protocol between two virtual networks as claimed in claim 17, wherein in the procedure (C2), the second virtual IP can send out a plurality of different port data packets in a consecutive manner to the first NAT-based router, and the first virtual IP can also send out a plurality of different port data packets in a consecutive manner to the second NAT-based router.

32. The direct peer-to-peer transmission protocol between two virtual networks as claimed in claim 31, wherein among the port data packets sent out by the second virtual IP, only one of the data packets can be successfully delivered to the first NAT-based router, whereas among the port data packets sent out by the first virtual IP, only one of the data packets can be successfully delivered to the second NAT-based router.
